(19) United States
(12) Patent Application Publication
(10) Pub. No.: US 2012/0189417 A1
(43) Pub. Date: Jul. 26, 2012

(54) Passive Ramp With Ramp Down Switch

(75) Inventor: Cedric J. Blough, Moundridge, KS (US)

(73) Assignee: AGCO CORPORATION, Duluth, GA (US)

(21) Appl. No.: 13/334,412

(22) Filed: Dec. 22, 2011

Related U.S. Application Data
(60) Provisional application No. 61/427,288, filed on Dec. 27, 2010.

(51) Int. Cl. A01F 15/08; A01F 15/07

(52) U.S. Cl. 414/519; 701/49

(57) ABSTRACT

In an example embodiment, a baler with a bale clear indicator is provided. A passive bale ramp may be configured to deposit a bale clear of the path of a tailgate of the baler. One or more sensors may be used to determine the position of the passive ramp and whether a bale is clear of the ramp and the tailgate path and an indicator provided to notify an operator that the bale is clear. In one embodiment a bale up sensor is used to determine the position of the passive bale ramp. In another example embodiment, a ramp down sensor is used. In another example embodiment, a bale up sensor and bale down sensor are used to determine the position of the passive ramp.

### CROSS-REFERENCE TO RELATED APPLICATIONS

Under provisions of U.S.C.§119(e), Applicant claims the benefit of U.S. Provisional Application No. 61/427,288, filed Dec. 27, 2010, which is incorporated by herein by reference in its entirety.

### FIELD OF THE INVENTION

The present invention relates to balers and, more particularly, to a baler having a moveable tailgate and bale ramp.

### BACKGROUND

Passive bale ramps may be used for guiding a bale ejected from a baler onto the ground. To avoid interference between the tailgate and the ejected bale it is desirable to ensure that the bale is clear of the tailgate path before closing the tailgate. It is often difficult for an operator to determine whether the bale is clear of the tailgate path, however, due to several factors, such as the grade and firmness of the ground, the density of the bale and the difficulty of an operator to see behind the baler.

### BRIEF DESCRIPTION OF THE DRAWINGS

FIG. 1 shows an example embodiment of a baler with ramp clear indicator with a tailgate in a closed position and a passive bale ramp in an up position.

FIG. 2 shows an example embodiment of the baler with ramp clear indicator of FIG. 1 showing in dashed lines the movement of the tailgate from up to down and the passive ramp from a down position to an up position.

FIG. 3 shows an example embodiment of a baler with a bale clear indicator in which the passive ramp (shown in dashed lines) has received a bale and is moving downward.

FIG. 4 shows an example embodiment of a baler with a bale clear indicator in which the passive ramp in dashed lines has moved downward so that the bale is deposited outside the path of the tailgate.

FIG. 5 shows an example embodiment of a baler with a bale clear indicator in which the passive ramp has returned to an up position and the bale is clear of the tailgate pathway.

FIG. 6 shows an example embodiment of a baler clear indicator system.

FIG. 7 shows a flow diagram of an example method of the invention.

FIG. 8 shows an example embodiment of a user interface to indicate whether an ejected bale is clear of the tailgate path.

FIGS. 9A-9B shows an example embodiment of a display to indicate whether an ejected bale is clear of the tailgate path.

FIG. 10 shows an example embodiment of a baler having a bale clear indicator in which a first and second passive ramp sensor is employed.

FIG. 11 shows an example embodiment of a bale clear indicator system.

FIG. 12 shows a flow diagram of an example method of the invention employing a ramp down sensor.

FIG. 13 shows a flow diagram of an example method of the invention in which both a ramp up and ramp down sensor are used.

### OVERVIEW

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the example embodiments are discussed in the context of a hall effect sensor, it will be understood that the present invention is not so limited and that other types of switches, sensors, or the like may be used.

Some portions of the detailed description which follows may be presented in terms of procedures, steps, logic blocks, processing, and other symbolic representations of operations on data bits that can be performed on computer memory. Each step may be performed by hardware, software, firmware, or combinations thereof.

In an example embodiment a passive bale ramp is used in conjunction with a ramp clear switch to identify when an ejected bale is clear of the path of a tailgate of the baler. In an example embodiment, a baler includes a tailgate moveable along a path between a closed position and an open position for ejecting a bale from the baler and a passive ramp coupled to the baler and configured to deposit a bale ejected from the baler on the ground at a location clear of the tailgate path. The passive ramp may be moveable between a bale clear condition in which a bale is out of the path of the tailgate and a bale engaged condition in which the bale is in contact with passive ramp. Thus, the position of the passive ramp may be used in determining whether a bale is clear of the tailgate path. A switch may be provided to determine whether the passive ramp is in the bale clear condition. If the ramp is in a condition that the bale is clear of the path, then an indicator may alert the operator that the bale is clear of the tailgate path and that the operator can close the tailgate. In one example embodiment a single switch is used to determine whether the passive bale ramp is in an up position. In another example embodiment a first switch is used to determine whether the passive ramp is in the up position and a second switch is used to determine whether the passive ramp is in a down position. A controller may use information from the switches to determine whether an ejected bale is clear of the tailgate path.

An example bale clear system comprises a passive ramp configured to receive a bale and deposit the bale out of the path of a baler tailgate, the ramp moveable between a bale engaged condition and a bale clear condition; and a sensor to detect whether the passive ramp is in a bale clear condition; and an indicator to indicate that the bale is clear of the tailgate path.

An example method comprises determining whether a passive ramp is in an up position and if so, providing an indication to an operator that the bale is clear of the tailgate. For example, the up switch may be used to determine the position of the passive ramp.

Another example system comprises a first ramp sensor to determine whether the passive ramp is in an up position, a second sensor to determine whether the passive ramp is in a down position, and a controller coupled to the first and second sensor to determine whether a bale is clear of the tailgate pathway using data from the first and second sensor. The system may further comprise a display configured to indicate the position of the passive ramp and whether the bale is clear of the tailgate path. A user interface may also be provided to allow an operator to close the tailgate. In another embodiment the tailgate may be closed automatically after verification that the bale is clear of the tailgate.

### DETAILED DESCRIPTION

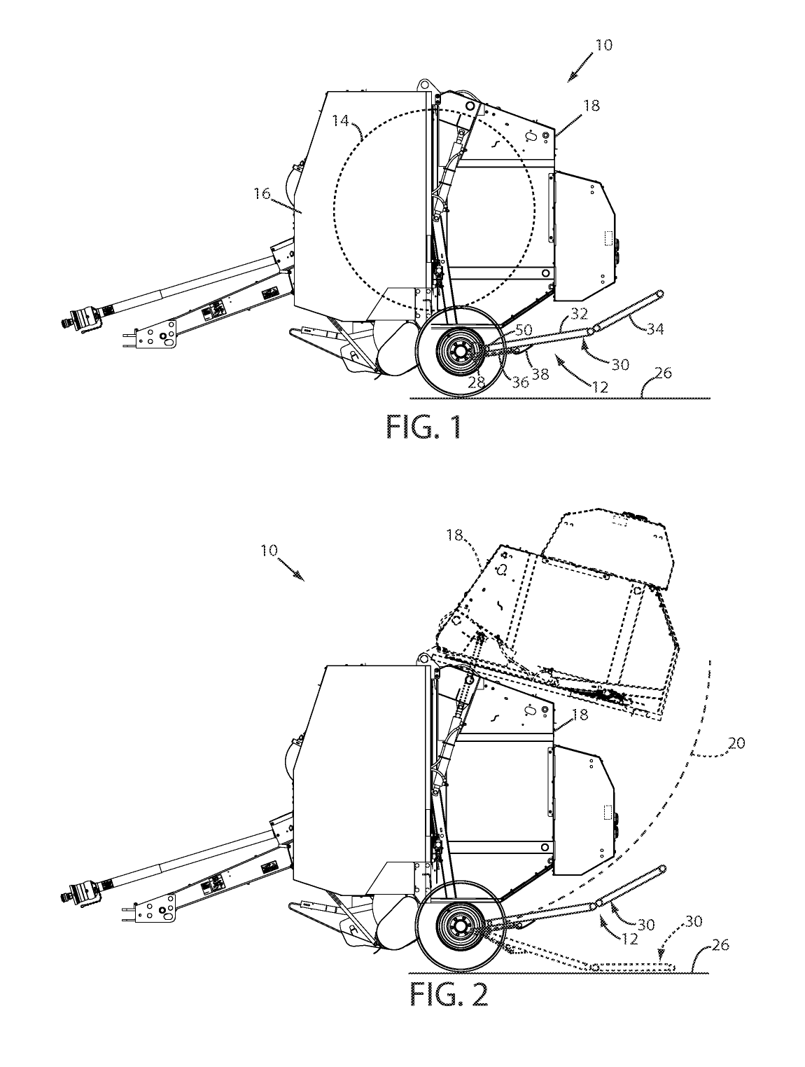

Turning to the figures wherein like numerals represent like elements throughout the several views, FIG. 1 shows a baler 10 with a bale clear indicator system 12. The baler 10 is operable to form a bale 14 in a baling chamber 16 and eject the bale 14 to a movable tailgate 18 that is operable for movement along path 20 between a closed position during bale forming and wrapping operations as shown in FIG. 1 and an open position for bale ejection as shown in dashed lines in FIG. 2. The baler may be similar to AGCO baler described in U.S. Pat. Nos. 6,477,824 and 6,675,561, which are hereby incorporated by reference in their entirety.

A passive ramp 30 may be movably coupled to the baler in cantilever fashion so as to move between an upward position for receiving a bale ejected from the baler 10 and a downward position for depositing the bale on the ground. In the example embodiment shown in FIGS. 1 and 2, the passive ramp comprises first 32 and second 34 support members for supporting a bale thereon. In the example embodiment, the support members 32, 34 may be angled with respect to one another to assist in depositing a bale on a surface 26 rearward of the baler 10. Depending upon the baler, the support members 32, 34 may take other forms, such as a single straight member, or two hinged members. A return spring 36 may extend between a frame 28 of the baler 10 and a mount 38 on the first support member 32. The tension of the spring 36 may be such that the passive ramp 30 moves downward when the bale 14 is ejected onto the ramp 30 to deposit the bale 14 on the ground 26. After the bale 14 is deposited the passive ramp 30 returns to the up position.

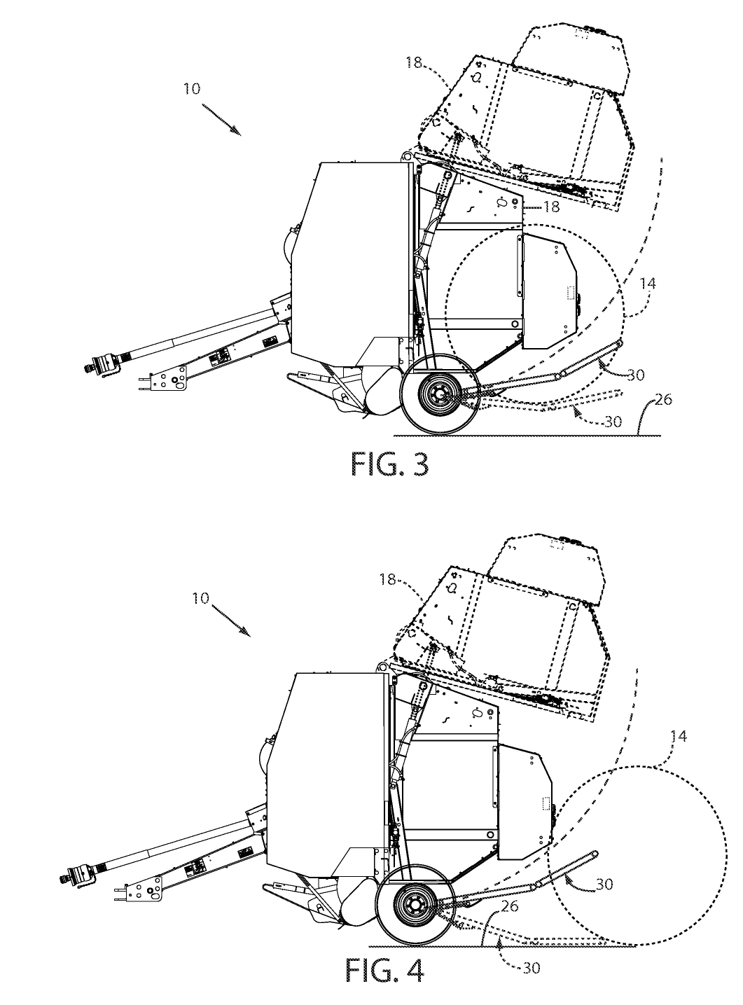

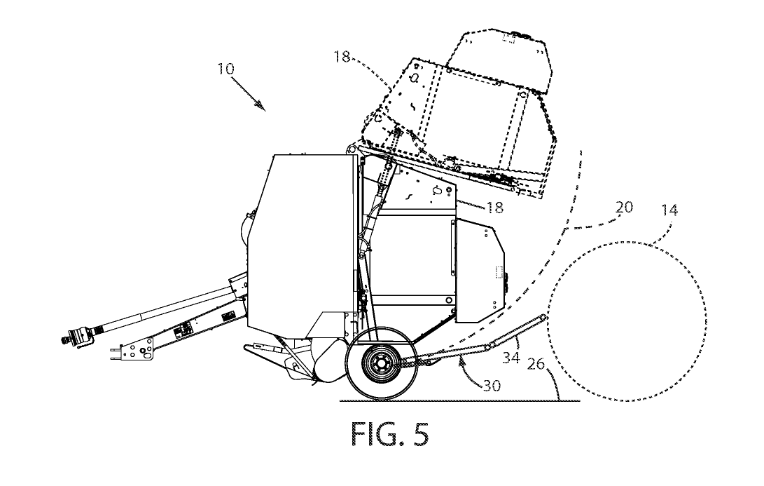

As shown in FIG. 3-5, the passive ramp 30 is configured so that a bale ejected from the baling chamber the bale 14 is deposited a distance from the baler 10 so that the bale 14 is out of the path 20 of the tailgate 18. As shown in FIG. 5 the angled support member 34 assists in preventing the bale from moving back into the path of the tailgate 18. In an example embodiment, the passive ramp 30 has a length of about 72 inches and a spring tension of about 1070 lbf in the ramp up position and 2430 lbf in the ramp down position. The configuration of the passive ramp 30 ensures that when the bale 14 has been deposited on the ground and the passive ramp 30 has returned to the up position that the bale 14 is not in the path 20 of the tailgate 18. Thus, when the passive ramp 30 returns to an up position, there is a bale clear condition.

As seen in FIG. 1, a sensor 50 may be used to determine the position of the passive ramp 30 and thereby determine whether the bale 14 is clear of the tailgate path 20. This information allows an operator to know that the tailgate 18 can be closed without interference from an ejected bale 14. In an example embodiment a Hall effect sensor 50 is used. For example, a magnet may be positioned on the support arm 32 and a transducer positioned at the baler to correspond to the magnet when the passive ramp 30 is in the up or bale clear position. For example, the transducer initiates a signal when the magnet is in proximity. This allows the sensor 50 to determine whether the passive ramp 30 is in an up position and the bale is clear of the tailgate.

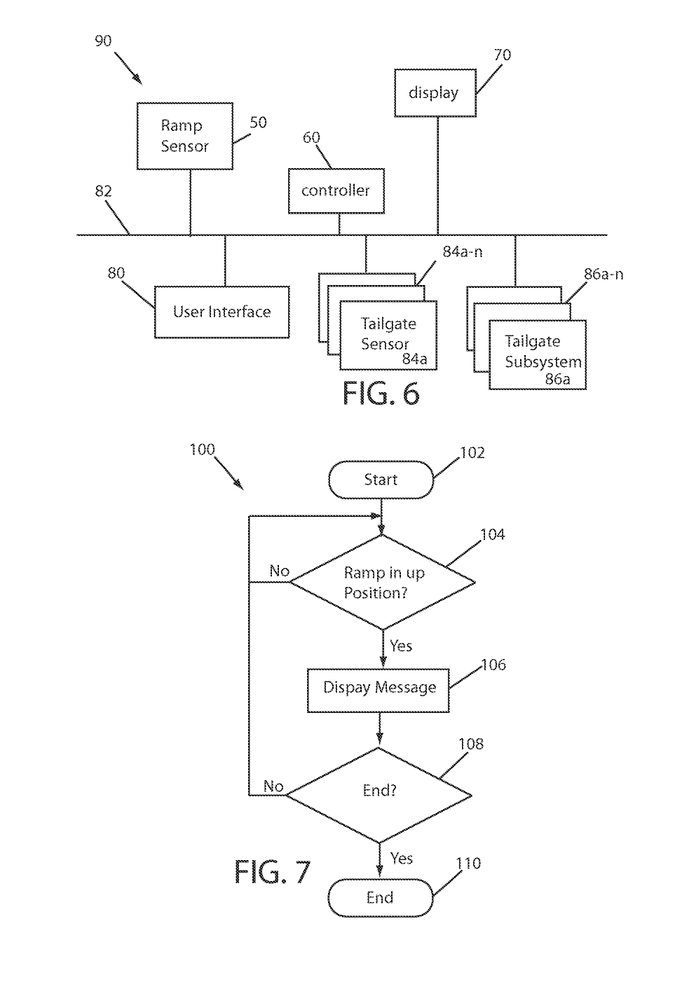

FIG. 6 shows an example embodiment of a bale clear system 90. As discussed above, a sensor 50 is communicatively coupled to the passive ramp 30 to determine the position of the passive ramp 30, such as whether the passive ramp is in an up position shown in FIGS. 1 and 5. The sensor 50 may be coupled to a controller 60 so that signals from the sensor 50 are received by the controller 60. The controller 60 may be software, hardware, and/or firmware and configured to determine a status of the bale 14 as either clear or unclear of the tailgate from the signals received from the sensor 50. In an example embodiment the controller 60 is a microcontroller.

A display 70 may be provided to notify the operator that the bale 14 is clear of the tailgate path 20. For example, the controller 60 may send command signals to the display 70. Although the controller 60 is shown as a separate element it could be part of the display 70. A user interface 80 may also be provided to allow an operator to manipulate the tailgate such as closing the tailgate when there is an indication that the bale 14 is clear of the tailgate path 20. For example, the user interface 80 and the controller 60 may be used to control a tailgate subsystem 86A to manipulate the opening and/or closing of the tailgate 18. The various components may communicate along a Controller Area Network (CAN) bus as known in the art. Various other subsystems 86 and sensors 84 of the baler may also communicate via the bus 82 with the other components.

FIG. 7 shows an example method 100 of the invention. The method is started at block 102. For example, the method may begin when the baler 10 begins operation. A determination is made at block 104 as to whether the passive ramp 30 is in an up position. For example, the sensor 50 of FIG. 1 may be used to determine whether the passive ramp 30 is in the up position. If the passive ramp is in the up position then a message may be displayed to an operator at block 106. For example a message may show text “Bale Clear” or “Ramp Up” to a user on the display 70. A determination is made at block 108 as to whether the process will be ended. For example, the baler may be turned off by the operator. If so, then the operation ends at block 110. Otherwise, the process repeats at block 104.

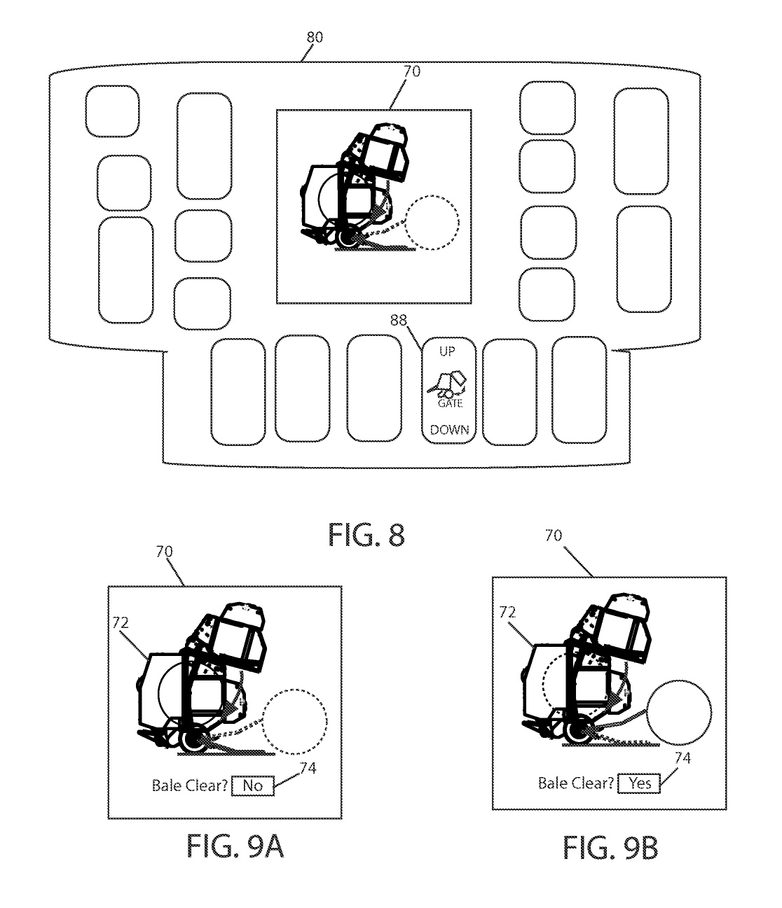

As shown in FIGS. 6 and 8, a user interface 80 may be provided. The user interface may include the display 70 and function keys, knobs, or other input means for receiving input from a user. The user interface may be similar to the user interface disclosed in U.S. Pat. No. 6,675,561 which are both incorporated by reference in their entirety herein and include various buttons, knobs, switches and the like to allow an operator to control the operation of the baler 10. For example, an operator may use the user interface to put the baler into various control modes and to operate various components of the baler, such as the pickup, twine or mesh wrap, etc. as known in the art. The user interface 80 may also include a tailgate switch 88 that allows a user to open and close the tailgate 18 as desired. As discussed, above, it is desirable that the tailgate 18 be closed after an ejected bale 14 is clear of the tailgate path.

The display 70 assists the operator in determining that an ejected bale 14 is indeed clear of the tailgate pathway to allow an operator to close the tailgate using the tailgate switch 88. In addition, if the baler is operated in an automatic mode, then the controller 60 may manipulate the tailgate 18 in accordance with a predetermined scheme, such as opening the tailgate during an ejection cycle and closing the tailgate once a bale clear indication is provided.

FIGS. 9A-9B show example embodiments of a display 70 to indicate whether the bale 14 is clear of the tailgate path 20. As shown in FIG. 8, the display 70 may be provided as part of the user interface 80. The display 70 may include an icon representative of the baler and the passive ramp to indicate that the passive ramp 30 position and the bale location. For example, in FIG. 9A the display indicates that the bale shown in solid lines is in an unclear condition in which it is in the tailgate path 20 and it is not desirable to close the tailgate 18. For example, the bale 14 could be either not yet fully ejected from the baler or still on the passive ramp 30. FIG. 9B displays a bale clear condition in which the bale is off the passive ramp 30 and clear of the tailgate path 20 so that the tailgate 18 may be closed. For example, the operator may close the tailgate 18 by using switch 88 to operate the various components of the tailgate subsystem 86a.

Other means of displaying the passive ramp 30 location and/or bale location may be used. For example, a field 74 may be used to indicate to the operator whether the bale is clear and the tailgate 18 can be closed without interference from the bale. Other indicators may also be used that will be apparent to one of ordinary skill in the art.

As shown in FIG. 6, various other baler sensors 84a-n may be communicatively coupled to the controller 60, which could be a baler main controller. For example, bale size sensors, twine sensors, mesh wrap sensors, etc. may be communicatively coupled to the controller 60 to provide information about the operation of the baler. Various subsystems 86a-n, such as a meshwrap subsystem, twine subsystem, kicker subsystem, tailgate subsystem, etc. may be coupled to and manipulated by the controller. These various sensors 84a-n and subsystems 86a-n may also communicate with the user interface 80 so that an operator can view the status of the baler and manipulate the baler subsystems. As shown in FIG. 6, a tailgate sensor 84a may be used to indicate whether the tailgate 18 is open or closed and a tailgate subsystem 86a may be manipulated by an operator using the input key 88 on the user interface 80. This may allow an operator, or the controller if operating in an automatic mode, to take into account information in addition to the position of the passive ramp, such as the position of the tailgate and whether the kicker has ejected the bale, in manipulating the tailgate 18.

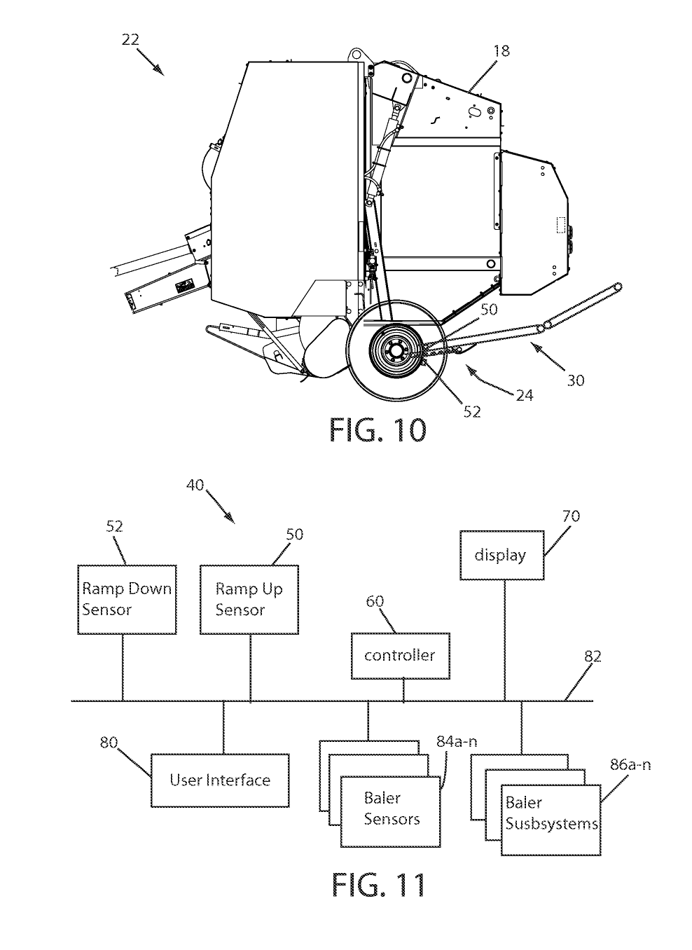

FIG. 10 shows an example embodiment of a baler 22 having a passive bale ramp 30 with bale clear indicator system 24 having a ramp up sensor 50 and a ramp down sensor 52. The ramp down sensor 52 may be similar to sensor 50 but located at a position coincident with the passive ramp 30 in a down position to detect whether the passive ramp 30 is in a down position. Additional elements of the baler 22 may be similar to that of the baler 10 in FIG. 1 and will not be discussed in detail.

FIG. 11 shows an example embodiment of a system 40 that includes the ramp down sensor 52. The ramp down sensor may communicate over the bus 82 and provide information to the various components including the controller 60 and the user interface 80. The ramp down sensor 52 provides additional information in determining whether the bale 14 is clear of the tailgate path 20. For example, logic may be used to determine that the passive ramp 30 has first moved to a down position as shown in dashed lines in FIG. 4 prior to being in the up position shown in FIG. 5. This would ensure that the bale 14 has exited the baling chamber of the baler. For example, if the bale does not exit the baling chamber, the passive ramp 30 would remain in an up position which could indicate to the operator that it is time to close the tailgate, which would be undesirable if the bale is not ejected. The ramp down sensor 52 in conjunction with the ramp up sensor 50 can therefore require an appropriate sequence of movement of the passive bale ramp 30 in determining whether the tailgate 18 should be closed. For example, the system may require the sequence of a ramp down closure followed by a ramp up closure before indicating that it is time to close the tailgate 18. This would indicate that the bale 14 has exited the baling chamber 16, rolled down the passive ramp 30, and is clear of the tailgate path 20 because the passive ramp 30 has returned to the up position.

In another example method, the ramp down sensor 52 could be used independently of the ramp up sensor 50. The detection of the passive ramp 30 moving between a ramp down position and a non-ramp down position could be used to indicate that the bale 14 moved down and off the ramp so that the ramp is clear and the bale is out of the tailgate path 20.

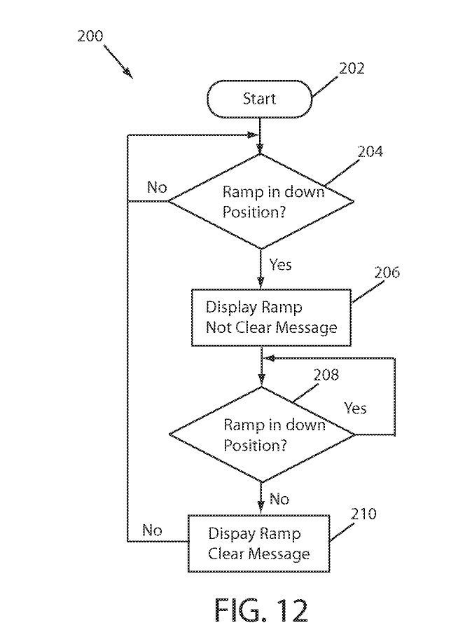

FIG. 12 shows an example method 200 of the invention when using the ramp down sensor 52. At block 202 the method starts, such as when an operator starts the baler 22 of FIG. 10. At block 204 a determination is made as to whether the passive ramp 30 is in the down position. For example, the sensor 52 shown in FIGS. 10 and 11 may be used to determine whether the passive ramp is in the position shown in dashed lines in FIG. 2. If the passive ramp 30 is in the down position, then a message may be displayed on the display 70, such “Bale Not Clear” or some other indicator to show that the bale is not clear of the ramp and the tailgate path 20.

At block 208 another determination is as to whether the passive ramp 30 is in the down position. If so, then rechecks are performed. If the ramp is no longer in the down position at block 208, then at block 210 a message is displayed on the display 70 that the bale 14 is clear of the passive ramp 30 and that the tailgate may be closed. For example, a message such as “Bale Clear” or the like may be displayed. The process may then be repeated. Thus, the system monitors the sequence of the movement of the passive ramp 30 to correspond to the deposit of the bale 14 from the passive ramp 30 to ensure that the bale 14 is clear of the ramp 30 and tailgate path 20 so that the tailgate may be closed.

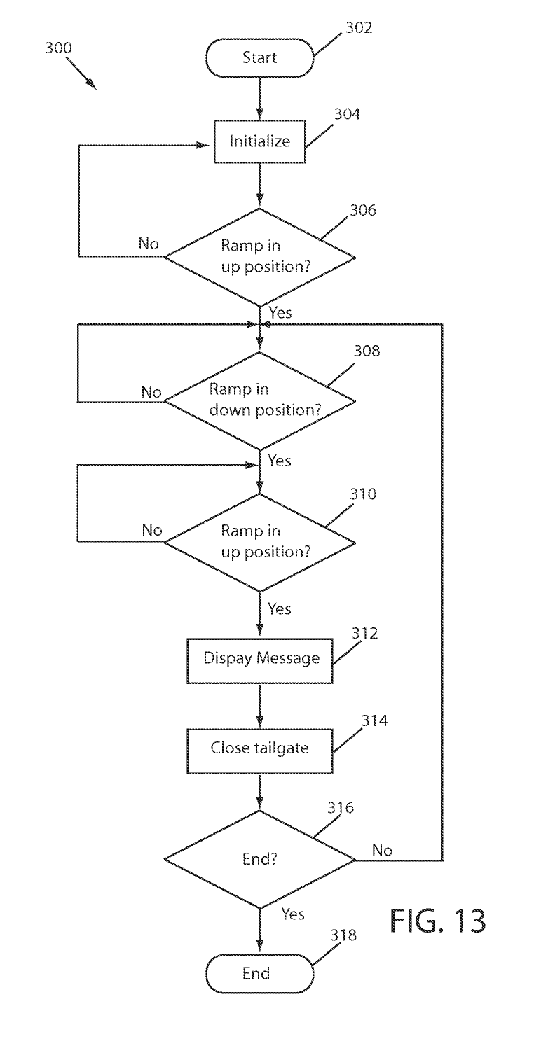

FIG. 13, shows an example method 300 that incorporates the use of both a ramp up sensor 50 and a ramp down sensor 52. At block 302 the method starts and at block 304 the system may be initialized. For example, the values of the sensors may be initialized to an initial value for use with the system. At block 306 a determination is made whether the passive ramp 30 is in the up position. For example, the ramp up sensor 50 may be used to determine whether the passive ramp 30 is in the up position. If the passive ramp 30 is not in the up position at block 306, then the process may not start until the passive ramp 30 is in the up position. For example, it may not be advisable to start the system with a bale 14 on the passive ramp 30. An error message may be sent to alert the operator that the passive ramp 30 should be in the up position when starting the baler.

If the ramp is in the up position at block 306 then a determination is made at block 308 as to whether the passive ramp 30 is in the down position. For example, the ramp down sensor 52 may be used to determine whether the passive ramp 30 is in the ramp down position. If the passive ramp 30 is not in the ramp down position then a new check is made at block 308. If the passive ramp is in the down position at block 308, then at block 310 a determination is made as to whether the passive ramp has moved to the up position. For example, the ramp up sensor 50 may detect whether the passive ramp 30 has returned to the up position. If the passive ramp has returned to the up position at block 310, then a message may be displayed at 312 indicating that the bale 14 has rolled off the passive ramp 30 and is clear of the tailgate path 20. For example, the icon 70 and/or the field 74 may be used to indicate that the bale is clear.

Because the bale is clear, at block 314 the tailgate may be disclosed. For example, an operator may use the button 88 on the user interface to close the tailgate, or the controller 60 may close the tailgate automatically. At block 316 a determination may be made whether the process has ended, such as if the operator has stopped the baler 22. If so, then the method ends at block 318. If not then a new determination is made at block 308 as to whether the ramp has moved into the down position.

While the present invention has been described herein with reference to particular embodiments thereof, latitude of modifications, various changes and substitutions is intended in the foregoing descriptions. It is understood that the invention is not to be limited to the particular terms used in the following claims, but that the invention will include any and all embodiments and equivalents falling within the scope of the appended claims.

What is claimed is:

1. A ramp system for a baler having a tailgate moveable between an open and closed position along a tailgate path, comprising:
a passive ramp configured to receive an ejected bale from a baling chamber of a baler and deposit the bale on the ground outside the tailgate path, wherein the passive ramp is movable between an up position for receiving a bale from the baling chamber and a down position for depositing the bale on the ground outside the tailgate path; and
a sensor configured to detect if the passive ramp is in the down position.

2. The ramp system of claim 1, further comprising an indicator to indicate whether the passive ramp is in the ramp down position.

3. The ramp system of claim 1, further comprising a controller configured to receive signals from the sensor and in response determine whether the passive ramp is in a bale clear condition.

4. The ramp system of claim 3, further comprising an indicator configured to receive signals from the controller and indicate whether the passive ramp is in the bale clear condition.

5. A ramp system for a baler having a tailgate moveable between an open and closed position along a tailgate path, comprising:
a passive ramp configured to receive an ejected bale from a baling chamber of a baler and deposit the bale on the ground outside the tailgate path, wherein the passive ramp is movable between an up position for receiving the bale from the baling chamber and a down position for depositing the bale on the ground outside the tailgate path;
a first sensor configured to detect if the passive ramp is in the up position; and
a second sensor configured to detect if the passive ramp is in the down position.

6. The ramp system of claim 1, further comprising a controller configured to receive signals from the first sensor and the second sensor, wherein the controller is configured to determine whether the passive ramp is in a bale clear condition in response to the signals from first sensor and the second sensor.

7. The ramp system of claim 6, further comprising an indicator configured to receive signals from the controller and indicate the condition of the passive ramp.

8. The ramp system of claim 1, wherein the passive ramp is configured to place the bale on the ground clear of the tailgate path and prevent the deposited bale from moving into the tailgate path.

9. A method for determining whether a bale ejected from a baling chamber of a baler is clear of a tailgate path of the baler, comprising:
detecting that a passive bale ramp configured to receive the ejected bale and moveable between an up position and a down position is in a down position.

10. The method of claim 9, further comprising:
detecting that the passive ramp is no longer in the down position.

11. The method of claim 9, further comprising, before the step of detecting that the passive ramp is in the down position, the step of detecting that the passive ramp is in the up position.

12. The method of claim 9 further comprising:
detecting that the passive ramp is in an up position prior to the down position; and
detecting that the passive ramp has returned to the up position.

13. The method of claim 9, further comprising:
indicating whether the passive ramp is in a bale clear condition in response to the detected position of the passive ramp.

14. The method of claim 9, further comprising:
if the passive ramp is in the bale clear condition, closing a tailgate of the baler.
